(19) United States
(12) Patent Application Publication
(10) Pub. No.: US 2014/0026066 A1
(43) Pub. Date: Jan. 23, 2014

(54) USER INTERACTION-BASED WEBSITE OPTIMIZATION

(71) Applicants: Morris Samuel Fishman, Glendale, CA (US); Tarun Bhatia, Oak Park, CA (US)

(72) Inventors: Morris Samuel Fishman, Glendale, CA (US); Tarun Bhatia, Oak Park, CA (US)

(73) Assignee: Yahoo! Inc., Sunnyvale, CA (US)

(21) Appl. No.: 13/555,723

(22) Filed: Jul. 23, 2012

(51) Int. Cl. G06F 3/01

(52) U.S. Cl. 715/745

(57) ABSTRACT

A system, such as a user interaction-based website optimization system, for effectively evaluating performance of a website and/or webpage with respect to a specific user, and then being operable to automatically generate or adjust the website and/or webpage based on past performance of the web site and/or webpage and expectations of the user.

### BACKGROUND

1. Field

Example embodiments relate to website optimization based on user interaction with a website.

2. Description of the Related Art

Dynamic generation of webpages has become commonplace in the World Wide Web. Websites, such as Yahoo, have been dynamically generated for years. Often the dynamic generation of a webpage can be based on the specific user accessing the webpage. For example, a webpage may be generated according to the demographics of a user accessing the webpage. Also, for example, a webpage may be generated based on information a user enters into a web-based form (such as user preferences) or on the status of a user (such as where the user is a preferred member of a website).

Although some websites have achieved great success in generating webpages that are more relevant to their visitors, there is still room for improvement. For example, it would be beneficial for a web site to effectively evaluate its performance with respect to a specific user and then automatically generate its webpages based on that performance, so that its performance can be improved or at least can meet expectations of the specific user.

### SUMMARY

In one embodiment, an electronic device implemented method, including: receiving from a user, user event data associated with a user event on a webpage; creating or updating user experience profile data associated with the user according to the received user event data, wherein the user experience profile data includes preferences, tolerances, or thresholds of the user; and determining an aspect of the webpage to change, based on the user experience profile data.

In another embodiment, an electronic device implemented method, including: receiving a user request to access a webpage; changing an aspect of the webpage, based on user experience profile data associated with the user, wherein the user experience profile data includes preferences, tolerances, or thresholds of the user; rendering the webpage; and evaluating the changed aspect of the webpage, based on a user event occurring on the webpage.

In another embodiment, a system, including: a first electronic device operable to: receive user event data associated with a first user event on a webpage; and create or update user experience profile data associated with a respective user according to the received user event data, wherein the user experience profile data includes preferences, tolerances, or thresholds of the user; and a second electronic device operable to: receive a user request to access the webpage; change an aspect of the webpage, based on the user experience profile data; render the webpage; and evaluate the changed aspect of the webpage, based on a second user event occurring on the webpage.

### BRIEF DESCRIPTION OF THE DRAWINGS

The system may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates a block diagram of one embodiment of a network that can implement one embodiment of a user interaction-based website optimization system (UIBWOS).

FIG. 2 illustrates a block diagram of one embodiment of an electronic device that can implement an aspect of one embodiment of a UIBWOS.

FIG. 3 illustrates a flowchart of an example method that can be performed by an aspect of one embodiment of a UIBWOS.

FIG. 4 illustrates a flowchart of another example method that can be performed by an aspect of one embodiment of a UIBWOS.

### DETAILED DESCRIPTION OF EXAMPLE EMBODIMENTS

As mentioned above, dynamic generation of webpages has become commonplace in the World Wide Web. Also, basing such dynamic generation on user information, such as demographic information, preferences, or status of a user, is prevalent.

Although some websites have achieved great success in generating webpages based on user information, there is still room for improvement. For example, it would be beneficial for a website to effectively evaluate its performance with respect to a specific user and then be automatically generated based on that performance, so that its performance is improved or at least meets expectations of that specific user.

Described herein is a system, such as a user interaction-based website optimization system (UIBWOS), for effectively evaluating performance of a first webpage and/or web site with respect to a specific user, and then being operable to automatically generate the first webpage and/or website, based on past performance of the first webpage and/or website and the user's expectations. Further, the system may also provide for automatically generating or adjusting a second webpage and/or website, based on the past performance of the first webpage and/or website and the user's expectations.

In one embodiment, a computer implementing the UIBWOS may perform a first method. The first method may include receiving from a user, user event data associated with a user event on a webpage (such as one or more mouse-clicks or mouse-overs, or conversions), and creating or updating user experience profile data associated with the user according to the received user event data. The first method may also include determining an aspect of the webpage to change, based on the user experience profile data and/or other profile data (such as webpage profile data, audio content profile data, video content profile data, advertisement profile data, and/or advertiser profile data). Further, the first method may include storing the user experience profile data and/or the aspect of the webpage to change. The aspect of the webpage to change may include content placement and/or advertisement placement, for example.

In another embodiment, a computer implementing the UIBWOS may perform a second method. The second method may include receiving a user request to access a webpage, and changing an aspect of the webpage. The aspect of the webpage to change may include content placement and/or advertisement placement, for example. The change may be based on user experience profile data associated with the user and/or other profile data (such as webpage profile data, audio content profile data, video content profile data, advertisement profile data, and/or advertiser profile data). Furthermore, this change may occur subsequent to the receiving of the user request to access the webpage. Also, the user experience profile data of this second method may be the same profile data created or updated in the first method.

The second method may also include rendering the webpage subsequent to the changing the aspect of the webpage. Then after the rendering of the webpage, the method may include evaluating the changed aspect of the webpage, based on a user event occurring on the webpage (such as one or more mouse-clicks or mouse-overs, or conversions). The second method may also include updating the user experience profile data, based on the evaluation of the changed aspect of the webpage, and re-adjusting the aspect of the webpage, based on the updated user experience profile data. Further, the second method may include re-rendering the webpage subsequent to the re-adjusting the aspect of the webpage.

In yet another embodiment, the system (such as the UIBWOS) may include a first and a second electronic device (which may be the same device) for performing processes similar to those described above. For example, the first electronic device may be operable to: receive user event data associated with a first user event on a webpage; and create or update user experience profile data associated with a respective user according to the received user event data. The second electronic device may be operable to: receive a user request to access the webpage; change an aspect of the webpage, based on the user experience profile data; render the webpage; and evaluate the changed aspect of the webpage, based on a second user event occurring on the webpage.

Regarding content or advertisement placement, such aspects may include whether content or an advertisement is placed in a top, bottom, right, left, or center section of a webpage, for example. Content placement or advertisement placement may also include the frequency or percentage in which content or advertisements appear on a webpage. Also, content or advertisement placement may include whether content or an advertisement appears in a pop-up mechanism or the like, such as a pop-up menu or advertisement. Content or advertisement placement may also include which features are presented with respect to a section of content or an advertisement, such as size of a section, shape of a section, colors of a section, visibility or brightness of a section, and a percentage or an amount of images, video content, or audio content of a section, for example.

Regarding the user experience profile data, such data may include preference for that specific user such as preferences with respect to content or advertisement placement. Preferences with respect to content or advertisement placement may include preference in general or preferences with respect to a specific webpage, website, type of webpage, type of website, and/or content of a webpage or website, for example.

The user experience profile data may also include thresholds or tolerances with respect to content or advertisement placement. The thresholds or tolerances may include thresholds in general or thresholds or tolerances with respect to a specific webpage, website, type of webpage, type of website, and/or content of a webpage or website, for example.

For example, in general, a specific user may tolerate webpages that include at most thirty percent advertisements. However, in particular, a specific user may tolerate webpages containing sporting news content that include at most fifty percent advertisement. Another example of user experience profile data may include that the specific user has zero tolerance for pop-up advertisements on any webpage, except for when pop-up advertisements occur in automotive type websites. As can be imagined, the variations of user experience profile data can be abundant.

Also, other profile data, similar to user experience profile data, can include preferences, tolerances, and thresholds, such as preferences, tolerances, and thresholds belonging to a webpage, a block of content, or an advertisement. For example, an advertisement for a webpage may have a threshold that requires the advertisement to be at least thirty percent of the webpage.

As can be imagined, there may be conflicts between user experience profile data and other profile data. Such conflicts may be resolved by logic (hardware and/or software based logic) of the UIBWOS, for example. This logic may include prioritization logic, such as a logic that prioritizes the profile data in general or specifically to a particular situation.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

The terminology used in the specification is for the purpose of describing particular embodiments only and is not intended to be limiting of example embodiments of the invention. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

Now, in order to more specifically describe example embodiments of the present invention, various embodiments of the present invention will be described in detail with reference to the attached drawings. However, the present invention is not limited to the example embodiments, but may be embodied in various forms. In addition, the detailed is not intended as an extensive or detailed discussion of known concepts. As such, details that are known generally to those of ordinary skill in the relevant art may have been omitted or may be handled in summary fashion.

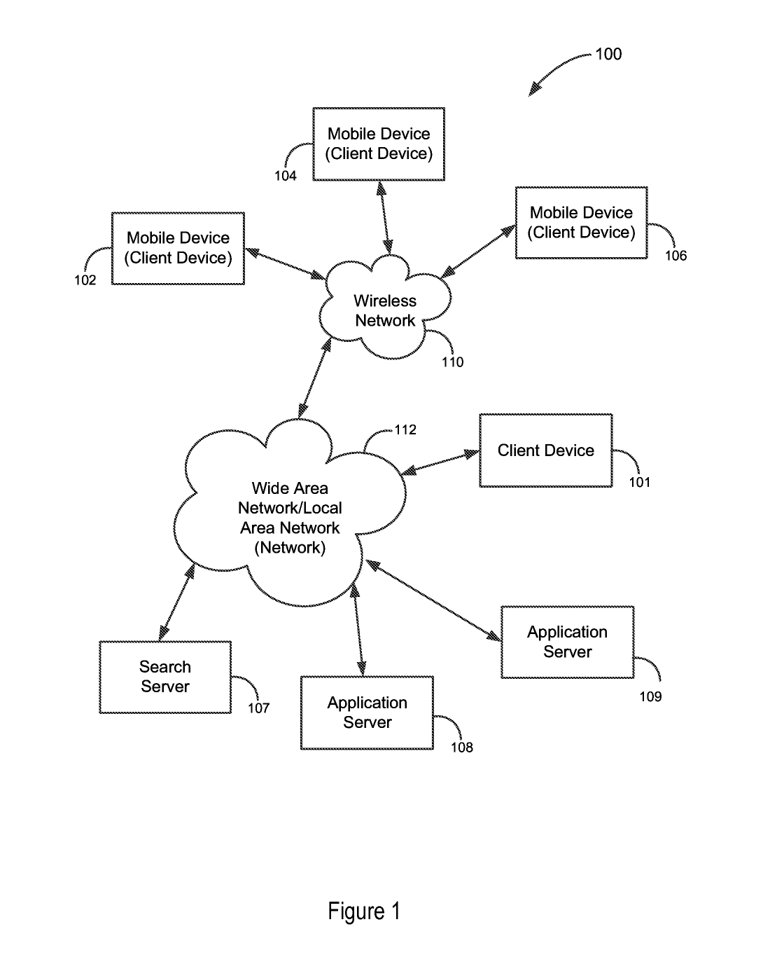

While example embodiments have been particularly shown and described with reference to FIGS. 1-4 it will be understood by one of ordinary skill in the art that various changes in form and details may be made therein without departing from the spirit and scope of example embodiments, as defined by the following claims.

FIG. 1 illustrates a block diagram of one embodiment of a network that can implement one embodiment of the UIBWOS. As shown in FIG. 1, for example, a network 100 includes a variety of networks, such as local area network (LAN)/wide area network (WAN) 112 and wireless network 110, a variety of devices, such as client device 101 and mobile devices 102-106, and a variety of servers, such as application servers 108 and 109 and search server 107.

A network, such as the network 100, may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network, such as wireless network 110, may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

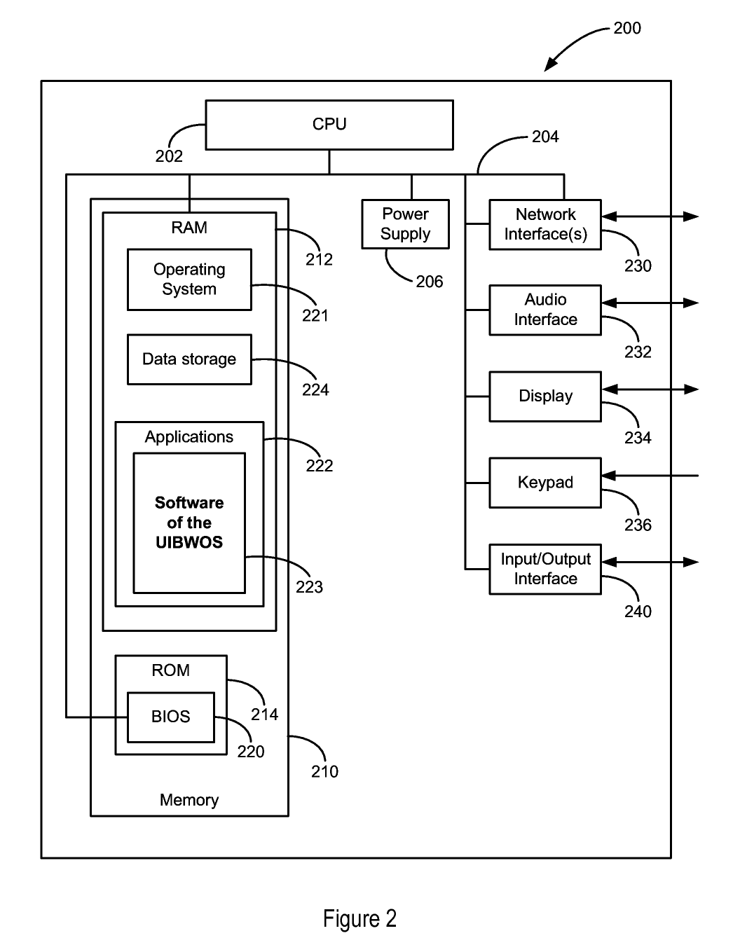

FIG. 2 illustrates a block diagram of one embodiment of an electronic device 200 that can implement an aspect of one embodiment of the UIBWOS. Instances of the electronic device 200 may include servers, such as servers 107-109, and client devices, such as client devices 101-106. A client device may be a desktop computer, a laptop computer, a tablet, or a smartphone, for example. In general, the electronic device 200 can include a processor 202, memory 210, a power supply 206, and input/output components, such as network interface(s) 230, an audio interface 232, a display 234, a key pad or keyboard 236, an input/output interface 240, and a communication bus 204 that connects the aforementioned elements of the electronic device. The network interfaces 230 can include a receiver and a transmitter (or a transceiver), and an antenna for wireless communications. The processor 202 can be one or more of any type of processing device, such as a central processing unit (CPU). Also, for example, the processor 202 can be central processing logic; central processing logic includes hardware, firmware, software and/or combinations of each to perform a function(s) or an action(s), and/or to cause a function or action from another component. Also, based on a desired application or need, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software. The memory 210, which can include RAM 212 or ROM 214, can be enabled by one or more of any type of memory device, such as a primary (directly accessible by the CPU) and/or a secondary (indirectly accessible by the CPU) storage device (e.g., flash memory, magnetic disk, optical disk). The RAM can include an operating system 221, data storage 224, and applications 222, such as an embodiment of software of the UIBWOS 223. The ROM can include BIOS 220 of the electronic device 200. The power supply 206 contains one or more power components, and facilitates supply and management of power to the electronic device 200. The input/output components can include any interfaces for facilitating communication between any components of the electronic device 200, components of external devices (such as components of other devices of the network 100), and end users. For example, such components can include a network card that is an integration of a receiver, a transmitter, and one or more I/O interfaces. A network card, for example, can facilitate wired or wireless communication with other devices of a network. In cases of wireless communication, an antenna can facilitate such communication. Also, the I/O interfaces, can include user interfaces such as monitors, keyboards, touchscreens, microphones, and speakers. Further, some of the I/O interfaces and the bus 204 can facilitate communication between components of the electronic device 200, and in one embodiment can ease processing performed by the processor 202.

Where the electronic device 200 is a client device, it can include a computing device capable of sending or receiving signals, such as via a wired or a wireless network. A client device may, for example, include a desktop computer or a portable device, such as a cellular phone telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

Also, a client device may vary in terms of capabilities or features. Claimed subject matter is intended to cover a wide range of potential variations. For example, a cell phone embodiment may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch sensitive color 2D or 3D display, for example.

Further, a client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages regarding operation or configuration of the UIBWOS. A client device may also include or execute an application to communicate content related to the UIBWOS, such as, for example, textual content, multimedia content, or the like. A client device may also include or execute an application to perform a variety of possible tasks, such as browsing, searching, or analyzing forms of content related to the UIBWOS.

Where the electronic device 200 is a server, it can include a computing device that is capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Further, a server may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Particularly, the server may be an application server that includes a configuration to provide an application, such as one embodiment of the UIBWOS, via a network to another device. Also, an application server may, for example, host a web site that can provide a user interface for one embodiment of the UIBWOS.

Further, an application server may provide a variety of services that include web services, third-party services, audio services, video services, email services, instant messaging (IM) services, SMS services, MMS services, FTP services, voice over IP (VoIP) services, calendaring services, photo services, or the like, all of which may work in conjunction with the UIBWOS. Examples of content provide by the abovementioned applications, including one embodiment of the UIBWOS, may include text, images, audio, video, or the like, which may be processed in the form of physical signals, such as electrical signals, for example, or may be stored in memory, as physical states, for example.

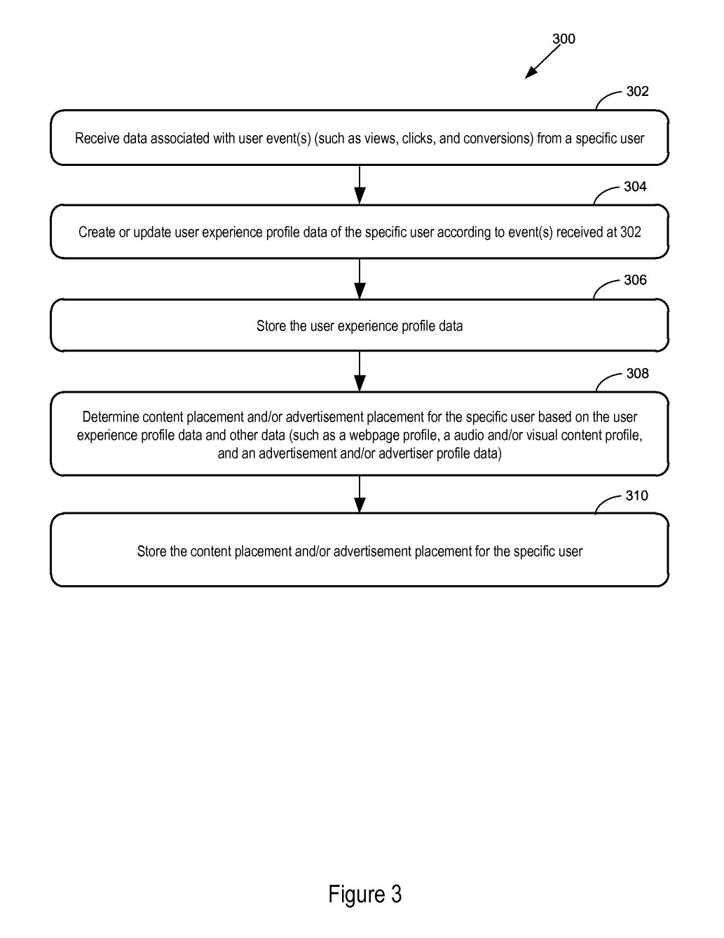

FIG. 3 illustrates a flowchart of an example method that can be performed by an aspect of one embodiment of a UIBWOS, such as the electronic device 200 (method 300). In short, the example method 300 includes creating or updating user experience profile data associated with browsing a website and determining a feature of that website based on the user experience profile data. In one embodiment, a processor (e.g., the processor 202, FIG. 2) can perform the method 300 by executing processing device readable instructions encoded in memory (e.g., the memory 210). In such an embodiment, the instructions encoded in memory may include a software aspect of the UIBWOS.

The method 300 begins with receiving data associated with one or more user events on a webpage, such as webpage views, mouse-overs and mouse-clicks, and conversions (at 302). In other words, an electronic device (such as the electronic device 200) receives data associated with a specific user's interactions with a webpage. One type of interaction, a conversion, may include any desired action based on subtle or direct requests from marketers, advertisers, and content creators on a website. For example, a user clicking on a pop-up advertisement may be considered a conversion. In other examples, a user completing a transaction, or providing a credit card number or electronic mail address, may be considered a conversion.

Next, the method 300 continues with creating or updating user experience profile data for the specific user according to the one or more user events received at 302 (at 304). For example, a software aspect of the electronic device creates or updates a profile associated with a user that includes information on the user's browsing habits. User interaction with websites may be monitored, logged and analyzed to develop the user experience profile data. The user experience profile data may also include demographic and preference information submitted by the user. Also, the user experience profile data may include thresholds for what the user will tolerate while browsing websites. For example, the user experience profile data may specify a percentage of advertisement space that the user tolerates on a webpage. Example traits for showing tolerance for a feature of a webpage may include how long a user will remain on a webpage having the feature or the conversion rate of that feature. A trait that may show a user's tolerance for advertisements is the percentage of advertisements clicked by the user, for example. These traits of the user experience profile data may also be specific to a particular webpage or website.

Next, the method 300 continues with storing the user experience profile data (at 306). The profile data may be stored in a database (such a database hosted by a server of the network 100). Alternatively, the user experience profile data may be stored on a client device used by the user.

Next, the method 300 continues with determining content placement and/or advertisement placement, for example, for the user, based on the user experience profile data (at 308). This determination may also be based on other data, such as webpage profile data, audio content profile data, video content profile data, advertisement profile data, and/or advertiser profile data. This aforementioned data may contain respective thresholds, priorities, and preferences. For example, webpage profile data may include an advertisement space threshold, a preference for positioning advertisements, and a priority list of preferred types of advertisements or preferred content of advertisements.

Finally, the method 300 continues with storing the content placement and/or advertisement placement, for example, for the specific user (at 310). This information may also be stored on a database hosted by a server or a client device.

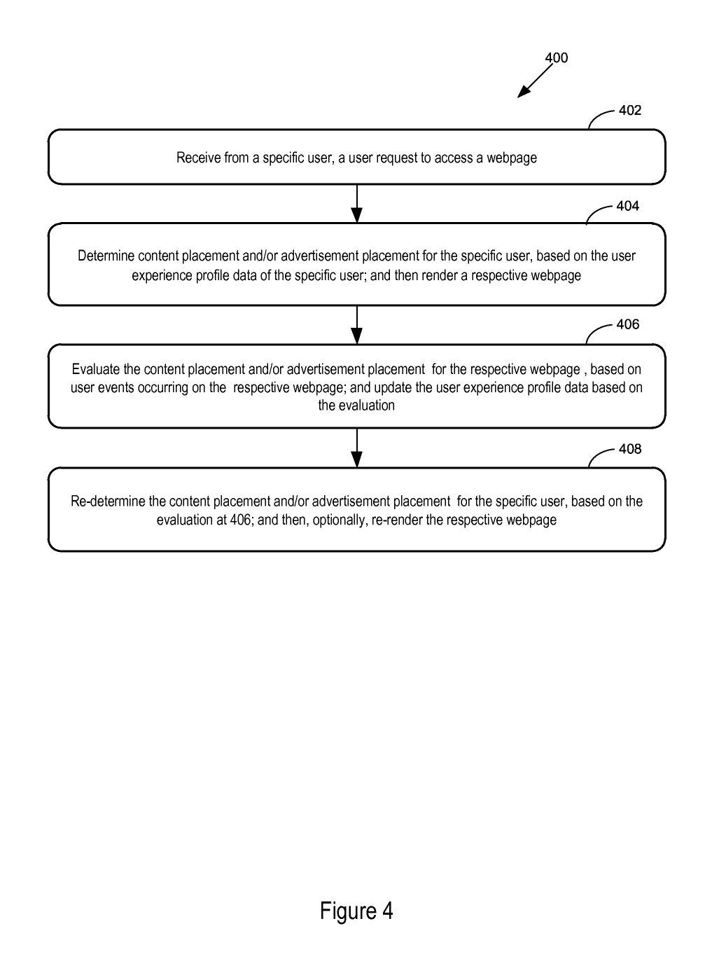

FIG. 4 illustrates a flowchart of an example method that can be performed by an aspect of one embodiment of a UIBWOS, such as the electronic device 200 (method 400). In short, the method 400 includes utilizing the user experience profile data to determine a particular rendering of a webpage, evaluating the particular rendering with respect to user interaction, and then updating the user experience profile data according to the evaluation. In one embodiment, a processor (e.g., the processor 202) can perform the method 400 by executing processing device readable instructions encoded in memory (e.g., the memory 210). In such an embodiment, the instructions encoded in memory may include a software aspect of the UIBWOS.

The method 400 begins with receiving a user request to access a webpage (at 402). For example, an electronic device (such as the electronic device 200) receives a request from a specific user to get a URL, so that the user can access a webpage associated with the URL. The user, for example, clicks on a hyperlink on webpage, such as a hyperlink in a list of search results, and that clicking of a hyperlink results in a request for a URL included in the hyperlink.

Next, at 404, the method 400 continues with determining content placement and/or advertisement placement, for example, for the user, based on the user experience profile data associated with the specific user. Then the respective webpage renders accordingly.

Alternatively or in addition, the determination of content placement and/or advertisement placement may also be based on other profile data, such as profile data belonging to a webpage, a block of content, or an advertisement, for example. As can be imagined, there may be conflicts between user experience profile data and other profile data. As mentioned above, such conflicts may be resolved by logic of the UIBWOS. This logic may include prioritization logic, such as a logic that prioritizes the profile data in general or specifically to a particular situation.

Next, at 406, the method 400 continues with evaluating the content placement and/or advertisement placement, for example, for the respective webpage, based on user events occurring on the respective webpage. Then the method 400 continues with updating the user experience profile data, based on the evaluation.

Next, at 408, the method 400 may continue with re-determining the content placement and/or advertisement placement, for example, for the specific user, based on the evaluation at 406. Then, optionally, the method 400 continues with re-rendering the respective webpage. This re-rendering may occur with or without a second request from the user to access the webpage.

As it can be imagined, there are various embodiments for providing and deriving the system described herein. It is therefore intended that the foregoing detailed description be regarded as illustrative rather than limiting, and that it be understood that it is the following claims, including all equivalents, that are intended to define the spirit and scope of this invention.

We claim:

1. An electronic device implemented method, comprising:
receiving from a user, user event data associated with a user event on a webpage;
creating or updating user experience profile data associated with the user according to the received user event data, wherein the user experience profile data includes preferences, tolerances, or thresholds of the user; and
determining an aspect of the webpage to change, based on the user experience profile data.

2. The method of claim 1, further comprising: storing the user experience profile data.

3. The method of claim 1, further comprising: further determining the aspect of the webpage to change, based on other profile data, wherein the other profile data includes webpage profile data, audio content profile data, video content profile data, advertisement profile data, or advertiser profile data.

4. The method of claim 3, wherein the other profile data includes preferences, tolerances, or thresholds belonging to the webpage profile data, the audio content profile data, the video content profile data, the advertisement profile data, or the advertiser profile data, respectively.

5. The method of claim 1, wherein the aspect of the webpage to change is content placement or advertisement placement, and wherein the content placement or the advertisement placement includes positioning and sizing respective content or advertising on the webpage.

6. The method of claim 1, further comprising: storing the aspect of the webpage to change.

7. The method of claim 1, wherein the user event is a conversion.

8. The method of claim 1, wherein the user event is at least one of a page view, mouse-click, or mouse-over.

9. An electronic device implemented method, comprising:
receiving a user request to access a webpage;
changing an aspect of the webpage, based on user experience profile data associated with the user, wherein the user experience profile data includes preferences, tolerances, or thresholds of the user;
rendering the webpage; and
evaluating the changed aspect of the webpage, based on a user event occurring on the webpage.

10. The method of claim 9, wherein the user event is at least one of a page view, mouse-click, mouse-over, or conversion.

11. The method of claim 9, wherein the aspect of the webpage is content placement or advertisement placement.

12. The method of claim 9, further comprising: updating the user experience profile data, based on the evaluation of the changed aspect of the webpage.

13. The method of claim 12, further comprising: re-adjusting the changed aspect of the webpage, based on the updated user experience profile data.

14. The method of claim 13, further comprising: re-rendering the webpage, subsequent to the re-adjusting the aspect of the webpage.

15. The method of claim 9, further comprising: changing the aspect of the webpage, based on other profile data, wherein the other profile data includes webpage profile data, audio content profile data, video content profile data, advertisement profile data, or advertiser profile data.

16. The method of claim 15, wherein the other profile data includes preferences, tolerances, and thresholds belonging to the webpage profile data, the audio content profile data, the video content profile data, the advertisement profile data, or the advertiser profile data, respectively.

17. A system comprising:
a first electronic device operable to:
receive user event data associated with a first user event on a webpage; and
create or update user experience profile data associated with a respective user according to the received user event data, wherein the user experience profile data includes preferences, tolerances, or thresholds of the user; and
a second electronic device operable to:
receive a user request to access the webpage;
change an aspect of the webpage, based on the user experience profile data;
render the webpage; and
evaluate the changed aspect of the webpage, based on a second user event occurring on the webpage.

18. The system of claim 17, wherein the first user event and the second user event are at least one of a page view, click, or conversion, respectively.

19. The system of claim 17, wherein the first electronic device and the second electronic device are the same electronic device.

20. The system of claim 17, wherein the aspect of the webpage is content placement or advertisement placement.
